(19) United States
(12) Patent Application Publication
(10) Pub. No.: US 2006/0100892 A1
(43) Pub. Date: May 11, 2006

(54) System and method for neighborhood affinity based online environments

(76) Inventor: Manohar Ellanti, Fremont, CA (US)

Correspondence Address: Manohar N Ellanti, 622, MuirField Terr, Fremont, CA, 94536, US

(21) Appl. No.: 11/198,423

(22) Filed: Aug. 4, 2005

Related U.S. Application Data
(60) Provisional application No. 60/625,543, filed on Nov. 5, 2004.

(51) Int. Cl. G06Q 99/00

(52) U.S. Cl. 705/1; 707/7

(57) ABSTRACT

A system, method, and computer program product are provided that implement integrated on-line solution for related users (business or otherwise) of a NAF neighborhood the ability to interact with each other and automate and keep track of such interactions. In one embodiment, users/members of a NAF EC can enter requests/offers (wanted/looking for, sell/buy and other type of requests). Other users of that NAF EC can view and respond to any of such postings. In one embodiment, members of neighboring NAF ECs of an EC ecosystem, with mutual agreement between EC operators, will be able to view postings of other ECs. Neighborhood businesses can advertise to system users and/or subscribe and receive member postings for wanted, help, goods, and services. Local businesses can also distribute eCoupons to members of a NAF EC or to members across multiple NAF ECs to save cost and target and reward customers more effectively; and users will be able to search and print such eCoupons or send them on-line to businesses to claim those eCoupons. In one embodiment, residents of a property centric NAF EC or mini EC within another NAF EC can send maintenance requests to owners/manager of a property; and property owners can post property related maintenance or other projects/requests to one or more ECs of an EC ecosystem to get offers/bids for that work/project.

### CROSS- REFERENCE TO RELATED APPLICATIONS

The present Utility patent application claims priority benefit of the U.S. provisional application for patent No. 60/625,543 filed on Nov. 5, 2004 under 35 U.S.C. 119(e).

### FEDERALLY SPONSORED RESEARCH OR DEVELOPMENT

Not applicable.

### REFERENCE TO A SEQUENCE LISTING

Not applicable.

### FIELD OF THE INVENTION

The present invention relates generally to Internet on-line environment/eCommunities. More particularly, the invention relates to neighborhood affinity (NAF) based on-line eCommunity (EC)/environments.

### BACKGROUND OF THE INVENTION

Currently there are many portal solutions that cater to presentation of such things as news, finance, etc. Similarly there are on-line places for sale, auctions and other similar type of e-commerce activities. There are also sites that cater to blogging and other types of online expression essentially for people to express themselves and interact with others that come together based on common interest or topic or theme. However, none of them address needs of families, individuals, and businesses related to a neighborhood in terms of interacting with each other.

### BRIEF DESCRIPTION OF THE DRAWINGS

The present invention is illustrated by way of example, and not by way of limitation, in the figures of the accompanying drawings and in which like reference numerals refer to similar elements and in which:

The accompanying drawings, which are incorporated in and constitute a part of this specification, illustrate embodiments of the invention and together with the description, serve to explain the principles of the invention.

FIG. 1 illustrates an exemplary basic principle of NAF based ECs comprising model of physical neighborhood and a portal platform allowing the EC entities to interact online in accordance with an embodiment of the present invention;

FIG. 2a illustrates an exemplary NAF EC portal deployment housing one portal applications for one EC in accordance with an embodiment of the present invention;

FIG. 2b illustrates an exemplary NAF EC solution deployment housing two portals for two ECs in accordance with an embodiment of the present invention

FIG. 3 illustrates an exemplary world community comprising multiple ECs serving the same neighborhood in accordance with an embodiment of the present invention;

FIG. 4 illustrates an exemplary EC hierarchy comprising ECs at higher levels being parents to ECs at lower levels in accordance with an embodiment of the present invention;

FIG. 5 illustrates an exemplary EC ecosystem comprising multiple ECs in a cluster or in a hierarchy or a combination of both and interacting with each other through mediation servers if necessary in accordance with an embodiment of the present invention;

FIG. 6 illustrates the exemplary Active Yellow Page (AYP) entity in accordance with an embodiment of the present invention;

FIG. 7 illustrates an exemplary process involved in AYP registration comprising business entity registering with an EC portal operator for inclusion into AYPages in accordance with an embodiment of the present invention;

FIG. 8 illustrates exemplary EC applications used in support of EC portal operation as well as the concept of delinking deployment options for such application from EC portal in accordance with an embodiment of the present invention;

FIG. 9 illustrates exemplary components/features of NAF EC platform in accordance with an embodiment of the present invention;

FIG. 10 illustrates an exemplary process involved in EC members (both individual and business entities) posting projects/needs that are responded to by other members of the EC ecosystem in accordance with an embodiment of the present invention;

FIG. 11 illustrates an exemplary EC single sign on concept involving a member of one EC being allowed to sign on to other ECs of EC ecosystem according to an embodiment of the present invention;

FIG. 12 illustrates an exemplary process involved when an EC user visits a foreign EC web-site upon which the foreign EC uses EC single sign on processes to authenticate the user in accordance with an embodiment of the present invention;

FIG. 13 illustrates an exemplary EC Identity Services where EC operators choose to offer Identity services in accordance with an embodiment of the present invention;

FIG. 14 illustrates an exemplary NAF EC targeted advertising involving businesses choosing specific target criterion for their adds in accordance with an embodiment of the present invention;

FIG. 15 illustrates an exemplary process involved in submitting advertisement by business for NAF EC targeted advertising as well as the method and means used to collect statistics made available to businesses to evaluate the potential impact of marketing campaign in accordance with an embodiment of the present invention;

FIG. 16 illustrates an exemplary process of EC based searching involving hierarchical searching and aggregation of search/query results in accordance with an embodiment of the present invention; and

FIG. 17 illustrates an exemplary NAF based ECs, including property centric mini community, comprising model of physical neighborhood and a portal platform allowing the EC entities to interact online in accordance with an embodiment of the present invention;

FIG. 18 illustrates an exemplary Property Resident Relationship Management, PRRM, using EC principles and framework according to an embodiment of the present invention; and

FIG. 19 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objectives and in accordance with the purpose of the invention, a variety of techniques for implementing neighborhood affinity based online environments are described.

A system, method, and computer program product are provided that implement an integrated on-line solutions for related users (there can be regular as well as business members in an EC—both classes of members are simply called users in the rest of the document) of a NAF neighborhood the ability to interact with each other and automate and keep track of such interactions. In one embodiment, users can enter requests (i.e. post to the EC) for goods and services. Business as well as non-business users of that as well as those of other ECs within the EC ecosystem can view such postings and respond to the user through auction/bidding process or otherwise. This embodiment also includes e-commerce activities (buy/sell of goods/services) between users of NAF EC and in general between users of entire NAF EC ecosystem.

In other embodiments, users can additionally search in the neighborhood for businesses that can undertake a given project or supply a given item or provider a given service; the search solution may be based on building a database of businesses—built dynamically in real-time through publish/subscribe concept or built using centralized means.

In yet other embodiment, neighborhood businesses advertise to NAF EC users and/or subscribe and receive users postings users for help, goods, and services. They can also pull/subscribe to such information in real-time or otherwise from each EC directly or from a central server (one or more of them ) where such information may be maintained for the purpose of distributing to all parties to enable prospective entities to bid (using fixed or auction process) to fulfill the request the EC user has initiated.

In another embodiment, NAF EC is used for a property based neighborhood. In such applications, interactions between users associated with that property and its owners and neighborhood can be done through NAF EC platform. In such application, residents will be able to enter maintenance related requests to management/owner of that property. Also, if needed, the owner/management can post any property related work items to one or more NAF ECs (typically the NAF EC in which the property is located) to seek potential fulfillers. In one aspect, for property owners, particularly, those who own properties from remote locations, this offers convenient way of managing their relationship with the property and with its residents and the community.

In other embodiment of the present invention, local businesses can also distribute eCoupons to residents and property owners to save cost and target and reward customers more effectively, wherein residents will be able to search and print such eCoupons or send them on-line to businesses to claim those eCoupons.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

An aspect of the present invention is to describe framework and architecture for neighborhood affinity (NAF) based on-line environment/eCommunity solutions to fill the above mentioned needs. The architecture and framework models neighborhood entities and their relationships, and uses them in many different ways to enable interaction between entities of a neighborhood. The framework also supports e-commerce and other type of activities between entities associated with an EC. A fundamental part of neighborhood based on-line environments/ECs described in this invention is neighborhood affinity (NAF). A rich set of business solutions, described or otherwise in this invention, will be possible in NAF based on-line environments/ECs Not only that, NAF based ECs provide greater sense of belongingness thus allowing people to interact more freely than possible with any current non-NAF based online-EC solutions.

NAF based EC principles and business processes outlined in this invention also apply to building on-line environments/ECs for closed user groups (CLUGs), special interest groups (SIGs), and to building on-line environments/ECs based on other criterion and purposes. In some of these types of on-line environments/ECs the members may reside across a wide geographic area as opposed to members of a small neighborhood based EC. In some cases, such special communities may be contained in or overlay over a geographic area for which one or more physical NAF based ECs may already exist. Regardless of the geographic spread or extent of an EC, there is affinity of one kind or another associated with an EC. This affinity, generally called NAF, can be defined based on many criterions such as distance, interest, location association, and so on. In its simplest and most commonly used application, NAF will be based on physical neighborhood association. Also, multiple criteria can be used to define an EC's NAF; for instance, all members (people and businesses) of a particular city and of a particular interest. In general NAF provides a flexible and scalable framework to build ECs as will become clear in numerous examples, with variations of these examples/embodiments easily conceivable by those skilled in the art and such variations are not to be regarded as departure from the spirit and scope of this invention.

NAF ECs enable and foster social networking thus enabling community life style and culture of years gone by. Many individuals have inhibitions in directly interacting with others (neighbors) or initiating contact or asking help. NAF based EC on-line environments can help individuals overcome such inhibitions as well as make it easy for all in initiating discussions with others. Also, those for whom time and other constraints can be issues in interacting with their neighbors for help, information, or virtually for any need that potentially can be met by their immediate or greater community will find NAF EC on-line environments very useful. In general NAF based environments will help alleviate many of these problems and help people interact more and thus benefit from such interactions. Interactions comprise postings seeking or offering goods, services, help; postings sharing information, tools to inking with others, discussion boards and others. The NbrLinkIn embodiment explained earlier is one way of initiating contact with neighbors in one's own EC or in a distant EC. Another way for members to interact is casually asking for help/information related to things like school, community activities, fund raising, and so on through EC portal. As the portal is for a closed group of that community there is less of a concern that such question will go unanswered or that response will come from general internet users.

In one embodiment of this invention, the entities of an EC (the members of a neighborhood) have affinity to that neighborhood and its location. However, ECs where members have other types of affinity are possible and portal solutions for such communities are possible based on generalized NAF EC portal concept.

When principles of this invention are used for managing NAF based on-line communities/environments the term eCommunity (EC) will be used representing the on-line EC portal concept, framework, principles, and services. Also, in this document, EC is used as a notation representing an ‘affinity based on-line environment’.

Similarly NAF based EC features, when integrated with property management business processes (such as maintenance, leasing, renting, buying/selling, insurance, etc) provide greater opportunities and enhanced experience for everyone involved and associated with property based neighborhood. In the context of such application, the people and entities constituting a property based NAF on-line environment include: owners, residents, businesses, and others associated with that environment (i.e. property and its neighborhood). When principles of this invention are used to offer NAF based EC on-line environments and services as part of a property management solution or property management solution embeds and offers NAF based EC on-line environment, the term property and resident relation management (PRRM) will be used.

The terms EC, PRRM are used throughout this document for ease of reference and notation for the collective set of concepts outlined in this patent. Also, in this document, the terms ‘member’ and ‘entities’ are used interchangeably to refer to people and businesses associated with an EC. The term ‘EC ecosystem’ is used to refer to a set of ECs that interact with each other using EC mediation servers where needed.

NAF based ECs are built by modeling entities of a neighborhood along with their relationships, and enabling various types of interactions between them —both non-commerce and commerce oriented. As will be explained shortly, it will be possible to offer entity-to-entity interaction/transaction record keeping services to both parties as part of NAF based online ECs. The relationships and interactions can be individual-to-business, business-to-business, individual-to-individual and in general entity-to-entity. NAF based ECs also support interactions between members belonging to different ECs as will be explained further.

Each NAF EC is associated with an operator. The operator may use any means available to make sure members do belong to the EC. Such verification may be done using address or other information provided during or after registration or by endorsement of a member by an existing member (one means described in this disclosure and called EC NbrLinkIn).

In general, the invention supports on-line interaction, relationship, as well as transaction management between entities of the EC ecosystem. The invention, through its e-commerce framework supports buying/selling or auctioning of goods and services. The framework also supports transaction flows such as payments, invoice, documents, etc. between members of the EC ecosystem.

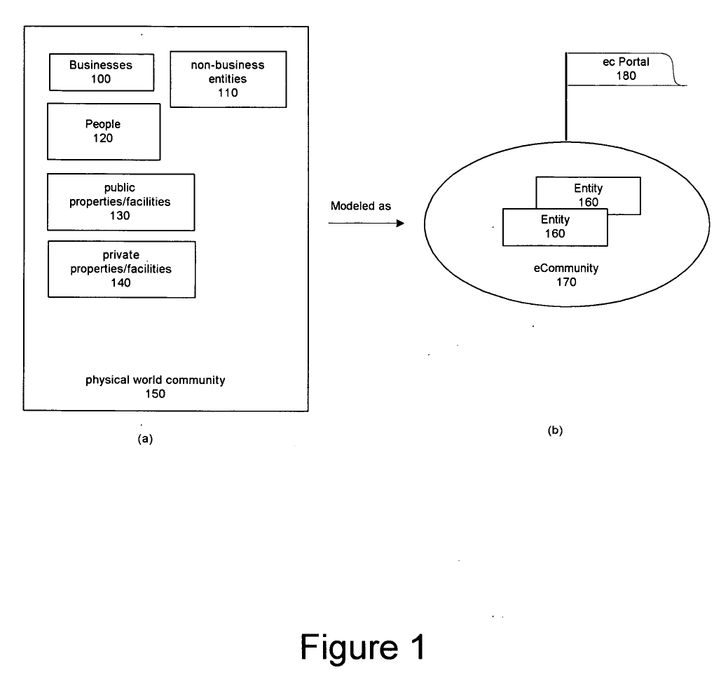

FIG. 1 illustrates an exemplary physical world (neighborhood) community and its equivalent model in accordance with an embodiment of the present invention. Physical neighborhood, 150, comprises business entities 100, non-business entities 110, people 120, public entities 130, and private entities 140. Other entities of a physical neighborhood can be classified into one of the above categories or modeled as a new class of entities. As shown, neighborhood 150 is modeled as EC 170 containing one or more entities 160 that model real entities of neighborhood 150. An EC portal application 180 provides an on-line platform for the neighborhood entities to interact, and share information as well as receive/offer services/help; buy/sell goods and services; bid/auction on goods and services. Other forms of interactions and business processes can be easily conceived using NAF based EC concepts.

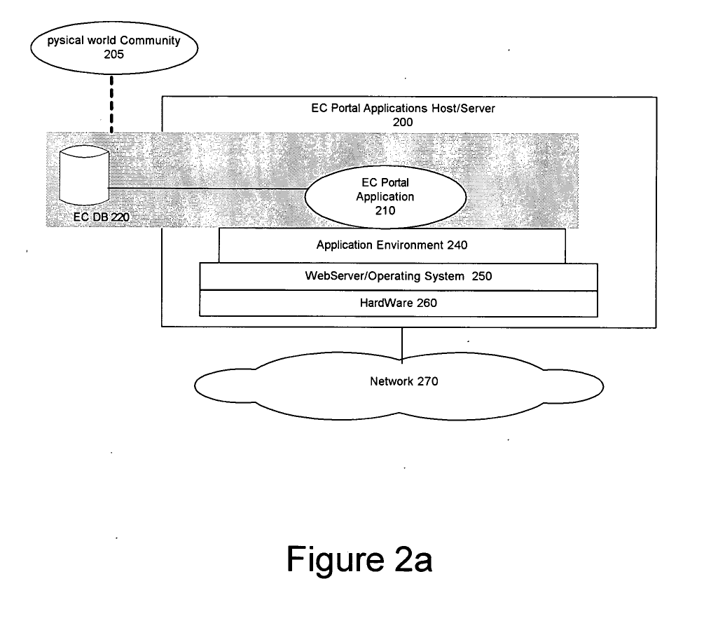

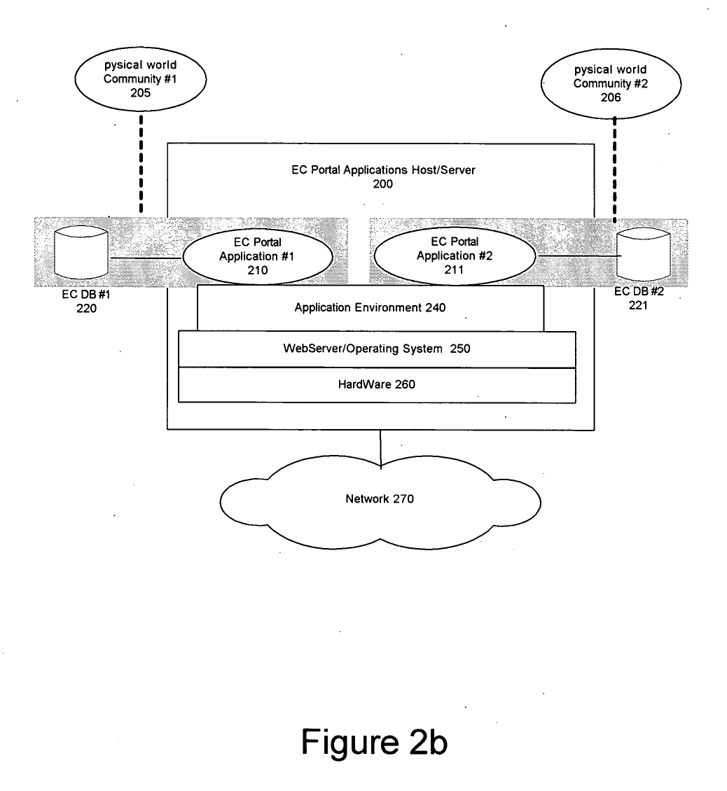

FIG. 2a illustrates an exemplary EC portal application server, EC portal application, and association with a physical world community in accordance with an embodiment of the present invention. EC portal solution deployment comprises application server 200 comprising application environment 240, WebServer/Operating System 250, Hardware 260. Application server 200 houses one EC portal application 210 and associated database DB 220 for a physical neighborhood 205. Server 200 connects to network (Internet) 270. For purposes of illustration, server 200 is shown hosting a single EC portal application 210 serving a single neighborhood 205. However, in accordance with an additional embodiment of the present invention, server 200 may house multiple portal applications as exemplified in FIG. 2b hosted by a single server 200. EC portal solution deployment comprises application server 200 comprising application environment 240, WebServer/Operating System 250 and Hardware 260. Application server 200 houses EC portal application 210, and associated database EC DB #1 220 for a physical neighborhood #1 205 and EC portal application 211 and associated database EC DB #2 221 for a physical neighborhood #2 206. Server 200 connects to network (Internet) 270. Alternatively, (not shown) a single. portal deployment may use multiple application servers. For the remainder of the description, an EC denotes a neighborhood, model of that neighborhood captured in NAF based EC framework, and EC portal application and any additional EC applications as may be needed and further explained with examples later on.

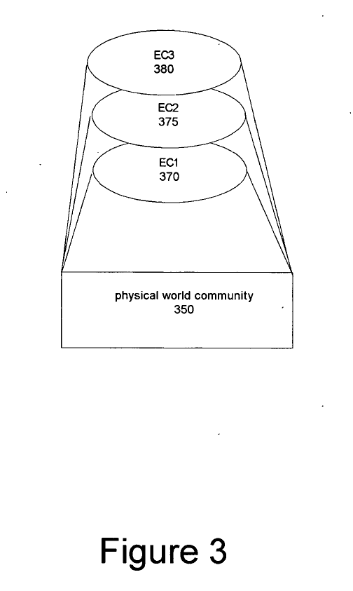

FIG. 3 illustrates an exemplary physical neighborhood 350 served by multiple ECs 370, 375, and 380 according to an embodiment of the present invention. A given member may choose to be part of one or more of these ECs (370, 375, and 380). Each of these ECs may have a NAF criterion that is different or the same as the other ones. The reach (either geographic or logical as defined by NAF criterion) of each EC may also be the same or different. In all cases, multiple ECs serving a neighborhood are considered as overlay ECs and the framework supports co-existence of such NAF ECs.

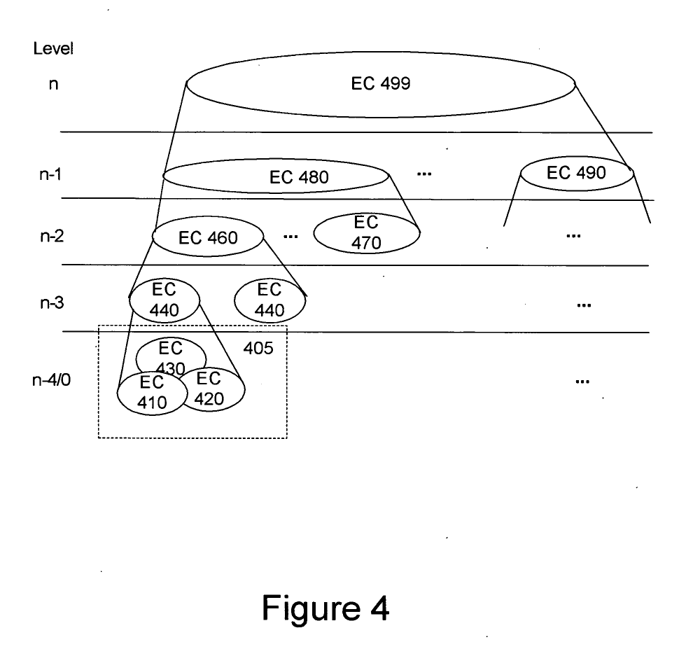

FIG. 4 shows hierarchical deployment of NAF on-line environments according to an embodiment of the present invention. NAF ECs can be deployed in a hierarchy, designated in FIG. 4 as level n, n-1, n-2, etc. Lowest level NAF EC, shown in FIG. 4 as EC 0, may correspond to a small neighborhood while a next level EC corresponds to a larger neighborhood demarcated by city or zip code or such criterion as makes sense to the EC portal operator. Members of lower level ECs may be automatically made members of higher level ECs where business makes sense. The framework supports such choice through EC Single-Sign on (SSO) concept to be described later. Not only that, since there can be multiple NAF ECs, spread across a geographic region, some or all of them (typically operated by the same operator) may form a cluster, for example cluster 405 shown in FIG. 4. An enabling embodiment for constructing EC clusters and offering easy entry into that cluster (or EC ecosystem) is the concept of EC Single Sign On (EC SSO) to be described later in this invention.

In general, whether ECs are deployed in hierarchical structure, level n, n-1, etc. or as a cluster 405 or a combination of both, a set of ECs that work together to offer seamless experience to members can be considered as forming an EC ecosystem. ECs in an ecosystem offer services to EC members regardless of which EC they belong to. Each EC may have policies as to what services are made available to visiting ECs as opposed to a local member. If automatic membership is given, as in hierarchical EC deployment, there may not be a concept of local vs. visitor; the scope of higher level EC is such that all members belonging to its child ECs will be considered local.

Through the concepts of hierarchical and clustering, or a combination of both, people (as well as businesses), neighborhoods, cities, regions, nations come together on-line and interact with each other at various levels forming an organized and structured web microcosm of ECs at neighborhood/local level and a macrocosm of ECs at higher levels. Essentially, physical world entities are represented as live active on-line entities with the support for interaction between the on-line equivalents.

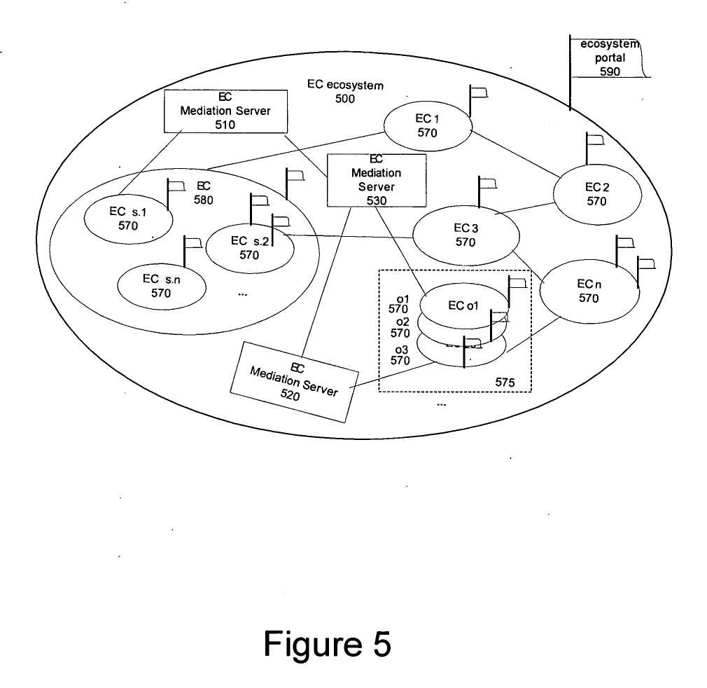

FIG. 5 illustrates an exemplary EC ecosystem with a portal for the entire ecosystem according to an embodiment of the present invention. Shown in the figure is EC ecosystem 500 comprising multiple NAF based ECs 570 each serving one or more physical neighborhoods. EC ecosystem 500 may span a region, a country, or the world. The invention constitutes each EC 570 being operated by an operator. A group of ECs operated by a single operator can constitute an EC ecosystem. Alternatively, where business arrangements exist, ECs operated by different operators may choose to be part of a single EC ecosystem. Also shown in FIG. 5 is an EC ecosystem 500 with EC mediation servers 510, 520, 530 (1, 2, . . . n) which are used for the purpose of facilitating and providing infrastructure to enable EC to EC interaction. Also illustrated in FIG. 5 is the concept of hierarchical ECs explained earlier; EC 580 contains EC s.1, EC s.2, EC s.n., 570. ECs, o1, o2, and o3 in EC 575 are overlay ECs serving the same neighborhood and the overlay concept introduced earlier. It is also possible for multiple EC ecosystems to exist. An EC in one ecosystem may interact with another EC in the same or a different EC ecosystem. ECs interact directly or indirectly using EC mediation servers.

FIG. 5 shows multiple ECs 570 interacting directly or indirectly, using mediation servers 510, 520, 530, via a network. One or more EC portal servers (for example portal servers associated with any of the ECs in FIG. 5) of an EC ecosystem can function as mediation servers but generally dedicated servers will be used to provide mediation functions for such applications as EC search, EC advertisement, EC discovery, and for postings of such things as sale/auction items and others that can be easily conceived by those skilled in the art.

Each EC ecosystem (or a group of them) will have a web-site that maintains a list of ECs in that ecosystem as well as take requests for creation of new ECs. The website also can display and maintain information that pertains to relationships between the ECs, marketing and other data-warehouse type of intelligence and made available to all or to some on subscription or other business arrangement basis.

The framework supports the ability to offer Active EC pages, i.e., directory based lookup services such as Active Yellow Pages (AYP); Active White Pages (AWPs); and Active Blue Pages (ABPs). AYPs are modeled as sections/pages of NAF EC Portal containing active content about business entities registered or otherwise in the EC. For each sponsoring business entity (called AYP entity or simply AYP), special sections/pages can be dedicated. Such sections/pages allow the associated business entity to manage its relationship with members of the EC for such purposes as displaying contact and other information. Extending this concept, to maintain and manage relationships with customers (i.e., customer relationship management—CRM) an EC business entity, in neighborhood and local context, can make use of special NAF EC AYP pages/sections. Such sections/pages being dedicated for an AYP are supported by one or more EC applications. As part of providing an online environment and platform to bring local businesses and customers in direct touch, the invention also envisions a business process that will involve NAF EC operator to have one or more call centers, supported by one or more EC applications, to make sure transactions initiated by members of ECs are acknowledged by fulfillers. Many other applications of AYP are possible given the overall framework of EC.

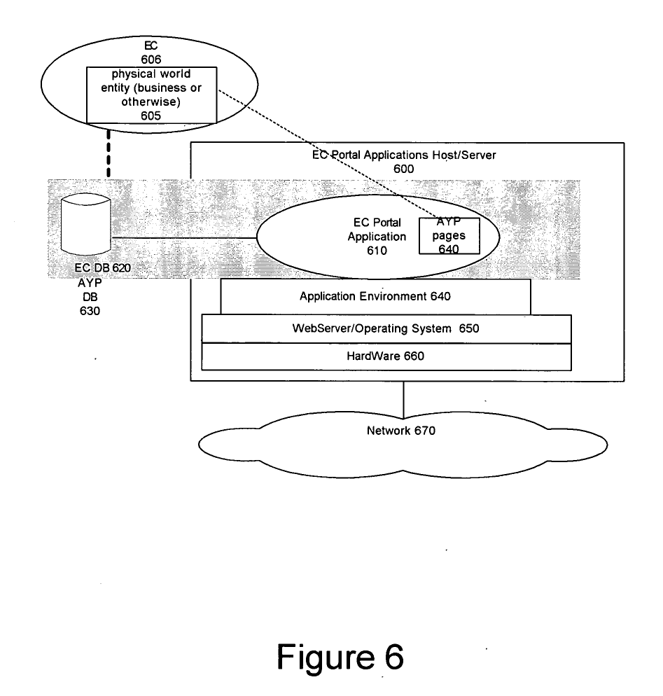

Such derivative applications or variations are not to be regarded as departure from the spirit and scope of the invention, and all such modifications as would be obvious to one skilled in the art are intended to be included within the scope of this invention. FIGS. 6, 7 and 8 are related to modeling of AYP, AYP registration, and EC applications in support of AYPs or other features of NAF ECs as set forth in this description.

FIG. 6 illustrates an exemplary EC portal application server, EC portal application and association with a physical world community of NAF based on-line environments in accord with an embodiment of the present invention. Physical world entity 605, such as a business entity serving a neighborhood advertises in AYP pages 615 within EC portal application 610 stored in AYP DB 630, a part of EC DB 620. For ease of reference, such business entity is commonly called an AYP (Active Yellow Page) entity—and referred to simply as AYP in this invention. Each AYP is provided special page(s) on NAF EC portal 600 and such pages are called AY Page(s) 615. An AYP associated with a given EC 606 can offer, through the EC platform, goods and services to members of the EC. A given business entity may be an AYP in multiple NAF ECs. Members of EC 606 can post comments, reviews, and ratings for each AYP of an EC. The ratings management set in NAF context is one embodiment of this invention. Many ways of presenting and managing the ratings and comments can be conceived and all such are additional embodiments of this invention. EC Members can also post questions asking for help or seeking businesses to contact them. An AYP may respond to such postings. All of this works using the concepts of NAF EC framework and as a result members can trust that the response is coming from a business entity within their community members don't have to screen further unless they decide to do so.

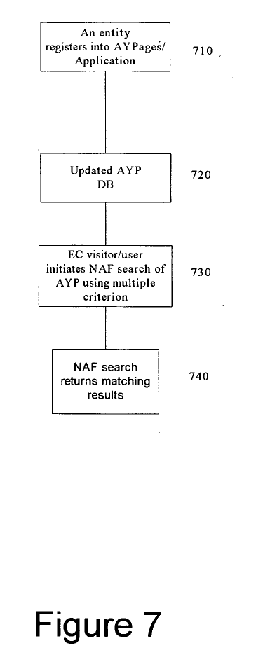

FIG. 7 illustrates an exemplary block diagram showing AYP registration and subsequent search by members of EC for business or other entities matching a specific NAF search criterion in accordance with an embodiment of the present invention. An entity registers into AYPages/application at Step 710. Registered information may include category, sub-category, and such information that will increase the success of direct hit as users search AYPs/NAF EC portal for NAF based businesses. Information entered by AYP is added to AYP database at Step 720 and at this step AYP sections/pages specific to the entity may be generated. One or more EC portal applications may be designed in support of the entity for such purposes as to present information about the entity to the EC, to let EC members interact with the entity and to meet the special business needs of the entity. At Step 730, when an EC visitor/user initiates a NAF search of AYP using multiple criterion, NAF search returns matching results at Step 740. The search, if the criterion allowed searching one or more other ECs, may return AYP entries across multiple ECs of an EC ecosystem.

One or more EC applications may be designed exclusively to deal with AYP needs and such applications can be hosted on an EC server, particularly the one hosting the EC Portal.

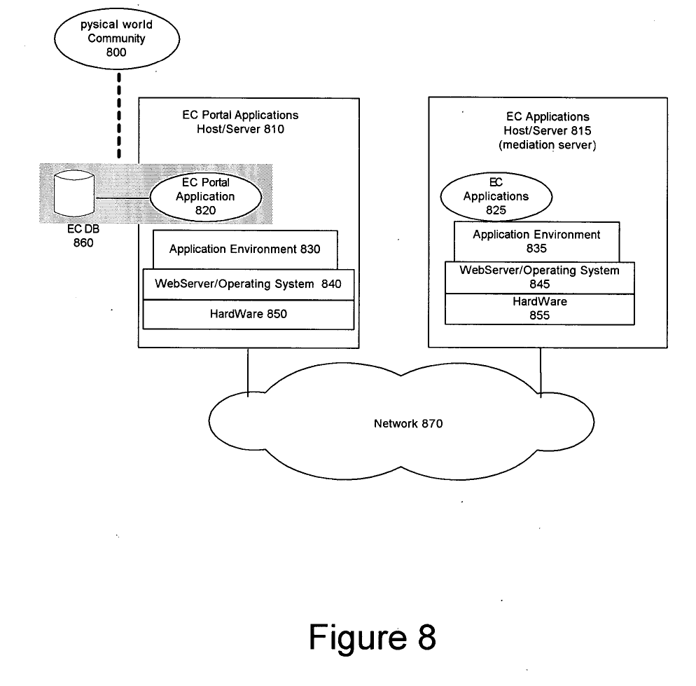

FIG. 8 illustrates an exemplary deployment of EC applications and relation to EC portals in accordance with an embodiment of the present invention. Servers 810, 815 comprises one EC portal application 820, and EC application 825 respectively, communicating with associated database 860 through network 870 for a physical community 800. Application environments 830, 835, webserver/operating systems 840, 845 and hardware 850, 855 comprise application servers 810, 815. EC servers hosting applications (called in the rest of the invention as EC applications) may host many other backend applications for instance, to perform data mining and other tasks for a single or multiple ECs. Another example of E application, a small business entity may have its online presence completely supported by EC portal (CRM application is one example explained earlier). Portal operators may decide to deploy special EC applications catering to the needs of such business. In order to ensure that orders from community members are indeed fulfilled by business, portal operators may choose to have one or more call centers to monitor the progress of orders initiated by members of EC to be fulfilled by AYPs. In-line listing of business entity information in a NAF EC framework and context is proprietary to this invention.

Various aspects of NAF ECs will be set forth in many of the following sub sections. Through these aspects, each EC essentially becomes a neighborhood information portal and scratch pad, one that is dynamic, up-to-date, and more reflective of that community. Such scratchpads are expected to be used/viewed ubiquitously using any and all available devices so users get to find necessary information essential for EC member's day-to-day life as well as enable EC members interact with their others in their community on-line. For business, local or otherwise, NAF EC platforms can provide more means and ways to reach out and engage with customers.

The architecture enables NAF on-line market places (extending across single or multiple NAF based eCommunities) that support B2C, B2B, and in general entity-to-entity (peer-to-peer or personal ecommerce, where entity can be business or individual) commerce in NAF context (meaning the initiator or source or both belong to eCommunity ecosystem). NAF based on-line market places provide better platform for business members of EC in terms of easy and direct access to potential and real customers of single or multiple ECs; for non business members, NAF based EC platform provides access to real businesses that serve or have a history of serving their community. Members can easily find goods/services in such marketplace. Both businesses and individuals can also place their goods/services for sale/auction.

An embodiment of the invention, through multiple business processes and architectural features listed explicitly or otherwise is paperless neighborhoods. This is enabled by record keeping, services of NAF ECs.

Record keeping service stores transaction details associated with any interaction (typically one that involves a transaction such as a sale/auction or service contract on home or other type of work) between EC entities. The parties involved in an interaction can be from the same or different ECs. One of the parties involved a transaction can be entity outside of EC ecosystem—such as an online book store, auction site, department store etc. Whether one or both parties of a transaction belong to an EC ecosystem, this invention envisions a business process where in all on-line transactions are maintained by EC on request by EC users. The specific means for capturing transaction information is not pertinent to the process, as is the core value offered by ‘one place record store’. This invention envisions this feature to help EC ecosystem members (individuals or organizations) with record/book keeping at first level (meaning first level details for the order at the minimum are stored—the member may need to visit the fulfiller's website for complete information). Such record keeping provides the benefit that EC members can see all their on-line transactions in one place as opposed to relying on confirmation emails and keeping track of those emails or dealing with hard copies thus enabling paperless. By avoiding hard copies and making sure all necessary information is archived the above process enables paperless neighborhoods

The storage (or record keeping) service concept conceived in this invention is unique in that, instead of providing raw storage, it provides application level information storage—receipts, payments, auxiliary documents (manuals, warranty documents) for EC users. Members can request any business (or otherwise) with whom the member conducts transactions to send all necessary invoices and documents to member's EC. Member can use such data for personal record keeping and for other purposes. For example, EC user may be able to find records pertaining to work done on user's home kitchen and call the vendor who did the work to fix any issue that might have come up. Alternatively one can find finer technical details of the work in such records. And, where applicable, users can transfer some or all of the records to others. For instance, home owners may be able to transfer a selective set of records to the next owner. Such records can be useful to the next owner. It is not necessary that monetary information is transferred or kept in the personal records. It is only business contact information, date of services, items of work and such details that usually are required for repairs and fixes. However, member will have full control of the information stored and can edit/delete what is kept in his storage.

An embodiment of this invention models a framework and business process where in EC portal can maintain an EC calendar that can be set by privileged members or portal operators reflecting important activities of the community. Users will be able to learn of upcoming events using such EC calendar. Additionally, businesses can buy calendar dates to advertise sale other events related to their business. The amount of information available with each day in the calendar can vary. Each portal maintains multiple calendars to meet its member needs. For instance, school calendar, community calendar, neighborhood stores sales calendar, community activity calendar etc.

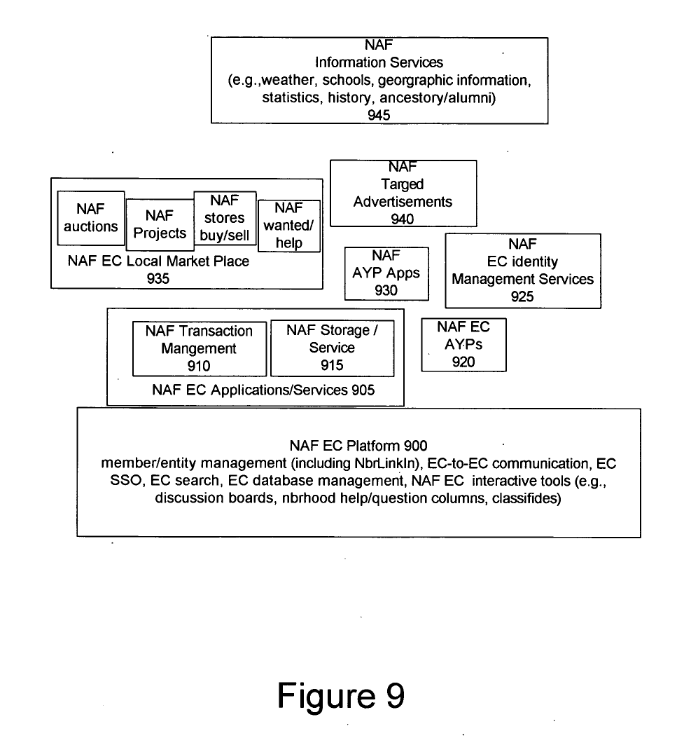

FIG. 9 illustrates an exemplary EC local market place, 935, along with other elements/features of EC in accordance with an embodiment of the present invention. The various modules of NAF local market place shown in the figure implement NAF concepts introduced earlier in support of various interactions, commerce or otherwise, between EC members; NAF auctions module implements support for on-line auctions in a NAF EC. Similarly, NAF Sales module implements sales process associated with selling goods/services by members (individual or businesses) in NAF EC. NAF projects module supports for entities of a neighborhood to post projects (such as home improvement or other projects) and for other entities to bid on such projects as fulfillers/service providers.

The EC framework includes support for multiple NAF EC IDs with a single EC account to minimize inconveniences associated with registering multiple accounts. Such capability is useful for users, particularly sellers and buyers, who may need to use multiple anonymous/or otherwise IDs. When there are multiple IDs this invention provides describes framework to maintain aggregate ratings derived from ratings of individual IDs associated with that entity. Ratings can be numerical such as 1-5 or enumerated (for instance, Excellent, Very Good, Good, Poor, unsatisfactory, etc). To explain the concept of aggregate rating, consider that a user X has three additional IDs A1, A2, and A3. Further, assume that user X posts sale items S1 with ID A1, S2 with ID A2, and S3 with ID A3. Now, further assume that buyer of S1 provides rating/feedback on A1 with a rating of R1, buyer of S2 provides feedback on A2 with rating of R2, and similarly buyer of A3 provides feedback on A3 with rating of R3. The rating for X will be an aggregate Function (R1, R2, and R3). The aggregate Function can be a simple average function or some advanced analytical function to arrive at the aggregate scoring.

Use of multiple IDs and aggregation of seller/buyer scores as explained above is an embodiment to this invention. The benefit of providing multiple IDs includes protection against identity theft as well the ability for NAF EC portal/on-line market place operators to ensure that sellers/buyers, if using the resources of the operator, remain anonymous so they don't bypass operator in the final transaction thereby ensuring that the operator does get a percentage of the transaction and such commission that is reasonable to support business associated with providing on-line environment/resources useful for buyers, sellers, providers, fulfillers.

Though not illustrated with a figure explicitly, an embodiment of the invention is similar to the NAF based EC SSO (to be described shortly) called the NAF NbrLinkIn. The process is explained with an example: an existing member (A) sends invitation to B, a neighbor or entity in the neighborhood, to join the EC in which A is already a member. Once B registers, A approves B's registration or if B submits credentials during registration, EC NAF Portal will automatically register B. The specifics of credentials and how they are verified is not relevant in so much as the process and benefits of NbrLinkIn.

Besides inviting new members to joining NAF EC, an existing member may also send requests to be linked with another member (an existing member) of the same or another EC. Regardless of how EC portals facilitate NbrLinkIn, the benefits of EC NbrLinkIn are many and some of them will be described explicitly but shall not be limited to just these. All other applications of NbrLinkIn that can be reasonably conceived based on the concept described here shall be considered as part of this invention

The first benefit of NAF EC NbrLinkIn is simplification of the job of EC portal operator in terms of ensuring, to the extent made possible by cooperation of existing members, that the new members are indeed meeting the NAF criterion. By delegating and involving existing members in verifying that new members do meet the NAF criterion set for that EC—the EC operator saves time and expense associated with verifying a new member's credentials. NbrLinkIn is particularly useful for city based ECs where the number of registrations can be fairly large on a daily basis. Such flexibility, wherein an existing member can approve or endorse a new member, encourages organic community building.

The second benefit of NAF EC NbrLinkIn is related to reduced marketing cost on part of NAF EC operators to draw new members to EC. Such reduction is possible since existing members take effort to invite (or endorse) new members.

For EC members, NbrLinkIn can provide such benefits such as ability to know more people of their community and make use of the same for many purposes. Also, the ability to see NbrLinkIn reach of self provides for entertainment/amusement possibilities besides opening up opportunities, business or otherwise; people can explore jobs or real estate using the NbrLinkIn. For instance, NbrLinkIn can show relationship of individual/business with others in that EC. Each entity in the EC can optionally store additional attributes which can be correlated in user defined fashion. Since NbrLinkIn extends across EC ecosystem, the ability to NbrLinkIn with people across NAF based EC ecosystem extends the benefits mentioned earlier instantly increasing the reach of a single individual or family or even business across EC ecosystem.

EC ecosystem (based on clustering, or hierarchical or combination of these) can additionally use EC single sign-on (EC SSO) concept to enhance user experience as users will be able to visit any EC in the EC ecosystem and view content or use features that are exclusive to EC ecosystem users. There are two embodiments associated with EC SSO with respect to EC user/entity; authenticator EC and home EC. Home EC is one with which EC user/entity has community association by way of residence or otherwise. In general, EC user/entity meets NAF criterion and is eligible to be member of a NAF EC for that EC to be chosen as home EC. User may have multiple home ECs if they have community association with multiple ECs. Authenticator EC is an EC that is chosen by user/entity to provide authentication of the said user/entity to EC ecosystem or even to external world (to be explained shortly). Users can choose to have multiple authenticator ECs. Such choice is based on the fact that multiple authenticators can provide sense of reliability. For instance, in a 2-way authentication scheme, one key is stored with one authenticator EC while the second key is stored with the second authenticator EC. Such multi-way authentication provides increased level of security and reliability which can be compromised only if both authenticator ECs are broken into by hackers.

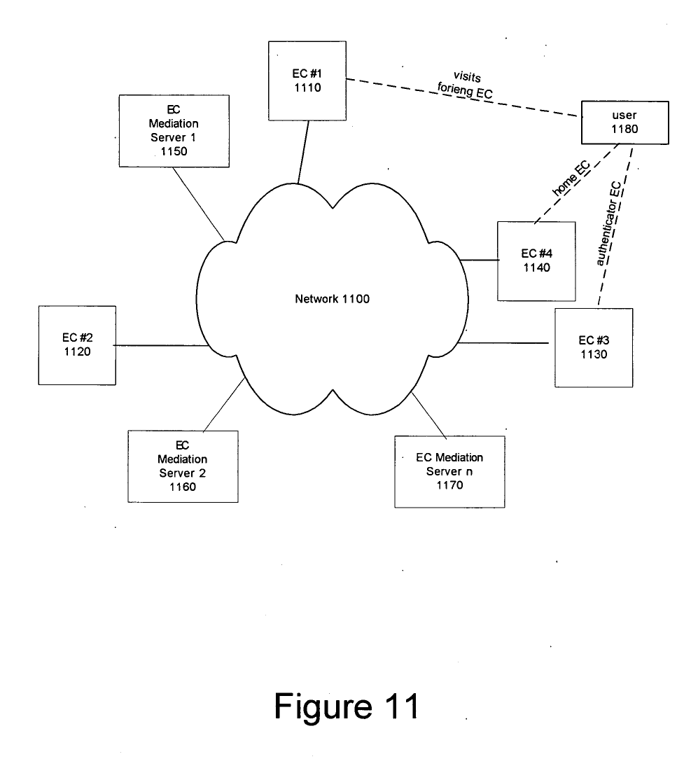

FIG. 11 illustrates an exemplary NAF EC SSO process; User 1180 logs into a home EC 1140 (an EC in which user is a member). From that login session, user navigates to other ECs 1110, 1120, and 1130 of the ecosystem. Each of these ECs (foreign ECs for the user) may have trusted and secure channel with user's home EC to obtain required credentials to recognize the EC user and offer appropriate level of access to content and features. When user is transferred to these other EC, the home EC may include direct or indirect information as part of the transfer to facilitate the other ECs in detecting that the user is coming from another EC. ECs 1110, 1120, 1130 use authentication services of home EC 1140 to authenticate user 1180. User 1180 may elect EC 1130, instead of home EC, to be his/her authenticator EC. When user is transferred from home EC to these other ECs, information about user's authenticator EC may be included in the transfer request as part of the URL or in a proprietary way and is not pertinent to the process involved. Once user is authenticated, ECs 1110, 1120, and 1130 let visiting user access content and features that are allowed as per each EC's access policies.

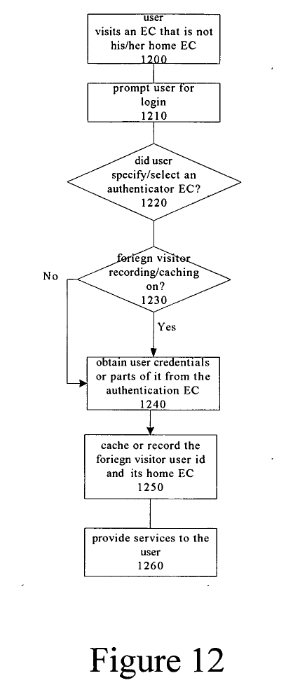

FIG. 12 illustrates another exemplary NAF EC SSO process where in a user visits an EC (let us say ECv) at Step 1200 and is prompted for a user login at Step 1210 along with the option for the user to specify authenticator EC. At step 1220 user elects the authenticator EC (ECa). At step 1230, ECv prompts user to turn on or off foreign visitor recording/caching, a memorization of user if that is useful. ECa at Step 1240 to obtain user credentials or parts of it. User may be allowed to specify a nickname that is specific to ECv so on future visits, user can use nickname to trigger the remote authentication without the user having to select authenticatior EC on future visits. Step 1250 will cache or record the foreign visitor's user ID and associated authenticator EC information. At step 1260 ECv provides access to content and features of that EC. The access offered depends on deployment and business considerations.

In general, user's authentication credentials are maintained in authenticator EC. Other ECs with which user interacts maintain additional information required to offer any customized services to the user. For instance, ECs 1110, 1120, 1130 in the first example above may choose to store such user specific data for user 1180 internally or with authenticator EC 1130. Generalizing, when user visits an EC (let us say ECv) it will contact user's authenticator EC. To learn about authenticator EC, ECv may prompt the user to input, if needed, his/her authenticator EC (ECa). Subsequently, ECv will let the authentication be handled by ECa. To accomplish this, ECv may redirect the user to ECa or get the login information from the user and transmit that over a secure channel to ECa and subsequently obtain required profile/credentials from ECa. Any of these or other schemes to facilitate EC SSO are not as important as the concept and the benefit it entails and in this regard any mechanism used to achieve EC SSO are considered part of this invention.

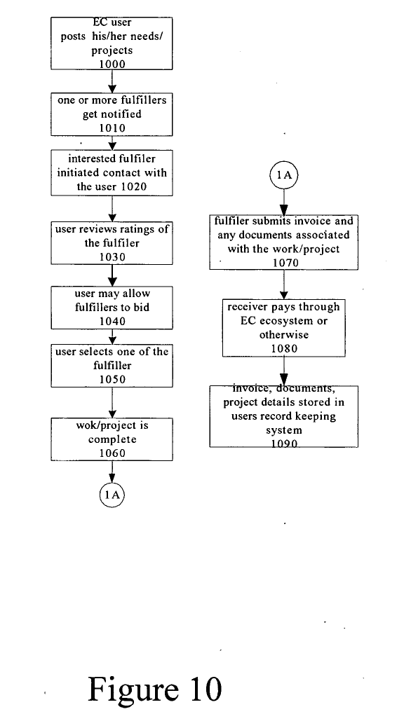

FIG. 10 illustrates an exemplary needs/project work flow involved in posting a project to a NAF EC according to one embodiment of the present invention. An EC user posts needs such as fulfilling a project at Step 1000. Only those AYPs and others that have subscribed get notified at Step 1010 and replies from these (the respondents or fulfillers) are sent to EC user at Step 1020. User may research about the responding entity at Step 1030 by examining EC reviews/ratings of the respondent including history of the fulfiller with the EC, how long the fulfiller has been in EC, how many customers have been serviced (if made public by fulfiller), feedback/ratings provided by EC members, etc. User may allow fulfillers to bid at Step 1040 then select one of the fulfillers at Step 1050 leading to project completion at Step 1060.

After the project is completed, at Step 1070, fulfiller submits one or more invoices/bills and any documents associated with the work/project. Receiver pays through EC ecosystem or otherwise at Step 1080. EC retains invoices/bills, documents, and project details in user's record keeping system at Step 1090.

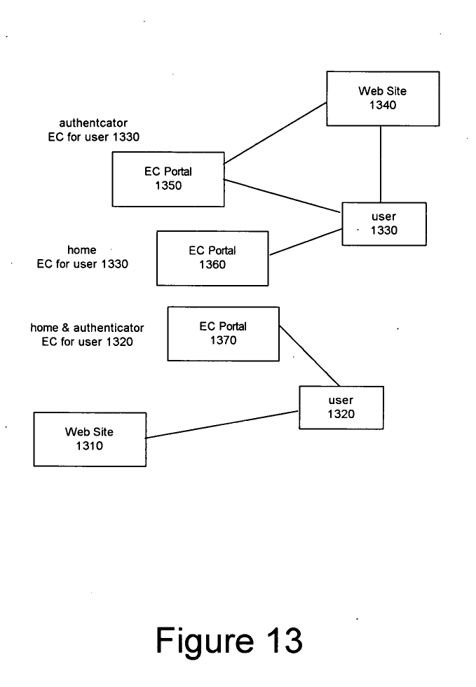

Additional embodiment of NAF EC framework is related to identity verification service. The ability to make use of EC framework to offer identity management/verification service provides for additional revenue opportunities for NAF EC portal operators. The opportunity to offer Identity management/verification services will be greater given that members of an EC are real and many local or other businesses can trust an EC operator to provide verification services. The process is similar to EC SSO except that when user goes to a web site outside of EC ecosystem or uses services on the Internet that require Identity verification—external websites will contact (user selected) authenticator EC to validate user identity. Regardless of how NAF EC based Identity verification service is realized it offers simplified on-line identity management. Plus give the framework outlined earlier, users can elect to have one or 2 or even more authenticator ECs to have n-way authentication for increased level of security. The external website may retrieve generic user profile parameters from the user selected authenticator EC as part of verifying the user. In addition to generic user information, each external web site may store additional information as necessary. It is also possible for users to store site-specific profile information with his/her EC portal and in which case, with suitable business arrangements, the EC portal can provide that additional information to the web-sites on request and through a secure channel and means. For instance, for a power user, a stock trading web-site might offer additional services based on user specific information stored with it or stored at the authenticator EC. FIG. 13 illustrates an exemplary application of EC based identity verification services in accordance with an embodiment of the present invention. EC portals 1350, 1360, and 1370 were chosen by users 1320, 1330 as their authenticator ECs. When user 1320 visits Web-site 1310 it will use authentication services of EC portal 1370. Similarly, when user 1330 visits web-site 1440 it uses authentication services of 1350, 1360 or both (as part of 2-way authentication scheme). It is not necessary for web-site 1310 or 1340 to store user authentication credentials though sites 1310 1340 might store other information specific to the user that will enable them to offer access to customized or generic content and features based on user specific information. Currently there exists no on-line means for targeting advertisements to geographies or regions or to ethnic/interest groups. Current generation of on-line marketing platforms can't deliver such targeting choices and effectiveness as NAF based concepts are fundamental to implement such targeted marketing platforms. By combining NAF as well as an overlay of interest or ethnicity attributes, on-line advertisements can be more effectively targeted thus benefiting the advertisers.

This architecture, as a result of NAF framework, allows a comprehensive and targeted on-line marketing/advertising platform to enable cost effective advertising solutions. The salient features of NAF based EC targeted marketing platform are targeted advertisement distribution, generation of market and business intelligence from aggregate purchase patterns, and preferences across single or multiple ECs of a region. Such intelligence is based on transactions done between entities of ECs (across same or different ECs) and the product/service category involved in the transaction. The market and business intelligence feature is unique for two reasons. First it is rooted in NAF based EC concepts. Currently such marketing intelligence is obtained by sifting through credit cards or other bills (obtained from databases). Thus multiple parties trample on a person's personal transactions. The person has no control and is not even aware that his/her privacy has been compromised. By providing marketing intelligence to businesses, businesses are prevented from sifting through people's credit cards and other bills thus protecting the privacy of people. Second, by aggregating information, privacy of members is maintained and focusing only on the category of items/services being bought/consumed and sold/delivered by groups of people as opposed to sifting through each person's records, the invention comprises a business process and method to better protect people's privacy. Not only that, all such aggregation is maintained outside of member's profile thus assuring privacy through aggregation.

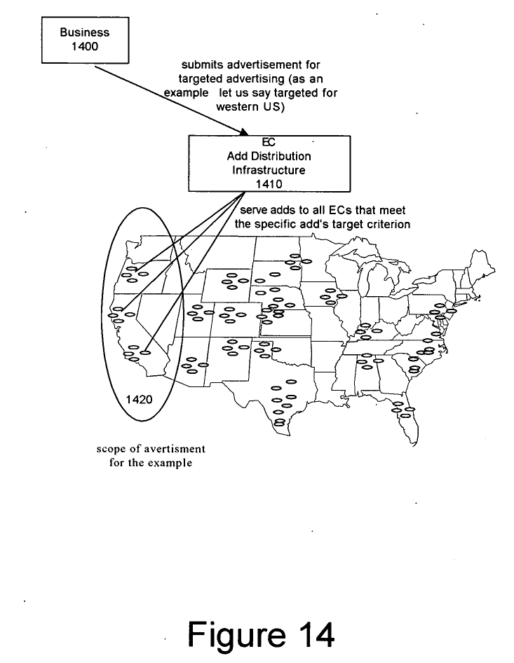

FIG. 14 illustrates NAF based targeted advertising in accordance with an embodiment of the present invention. In this embodiment, business 1400 chooses to have their marketing program run an EC ad distribution infrastructure 1410 over a specific geographic or target audience that is located in one or more ECs. As an example, targeted advertising may be the West coast of The United States 1420. There may be constraints—lack of budget to run such advertisement across all geographic areas, or customized marketing for each geographic/community but still part of a national or world wide marketing initiative. Currently there is no on-line marketing platform that can provide the flexibility needed for businesses to target their advertisement programs. NAF based targeted advertising provides a solution that businesses can take advantage of. This can be combined with keyword based advertising or simple banner type advertising within NAF context.

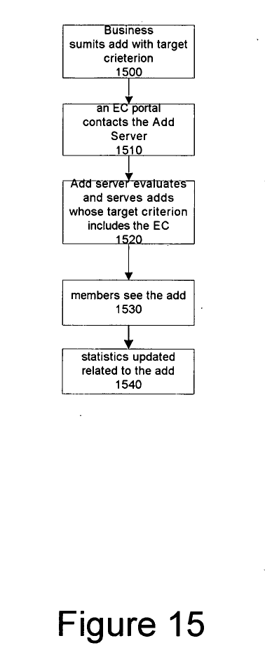

FIG. 15 illustrates an exemplary process involved in submitting an advertisement for targeted advertising in accordance with an embodiment of the present invention. A member business submits an advertisement with a target criterion at Step 1500 and EC portal contacts advertisement server at Step 1510. At Step 1520, ad server evaluates and serves ads whose target criterion includes the EC. An EC portal will have multiple pages and multiple locations on each page where ads can be placed. Though there may be multiple advertisements with the ad server, based on the EC NAF information, the page the user is currently visiting, in the ad server selects appropriate ad to be served. Members see ads at Step 1530 and Step 1540 collects updated statistics related to the ad in accord with common practice.

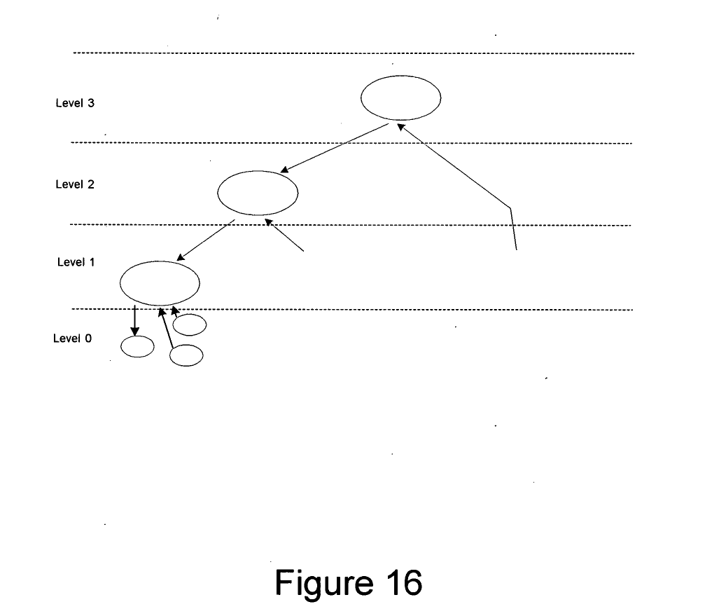

There are two aspects to NAF EC search. First, regardless of how NAF ECs are scattered and contained, visitors to an NAF EC portal, whether that portal is operating at level ‘0’ or at higher level, will be able to find things in all NAF ECs provided user qualifies for access restrictions set forth by each NAF EC. As an example, where level −1 and above communities are public communities, a person initiating a query from lowest level NAF EC to find things will be able to get results from all ECs. For instance, Person ‘A’ may visit ecPortal A (pA) representing his/her community or organization (profit or non-profit). The ecPortal, pA, in fulfilling the search request of its visitor ‘A’, will query one or more other ecPortals autonomously. The results, on the way back to pA, may be aggregated by intermediate ecPortals depending on the containment as shown with an example in FIG. 16. NAF EC search is first done in the member's EC by default. However, user can ask the search to be done across a specific set of ECs or across a geographic region or across a set of ECs meeting user's NAF criterion. In all cases where search extends outside of member's EC, the search process involves distributed searching where search results from individual ECs are aggregated by intermediate EC nodes in the hierarchy, an example of which is shown in FIG. 16. Other forms of optimization to make EC search efficient are possible and all such variations are to be regarded as with in the spirit and scope of this invention.

The second aspect of EC search is a derivative of NAF EC framework. Today, an immense amount of information is being generated by users using many different on-line products. All this data is maintained in an unstructured manner requiring complicated search expressions by users to get relevant search results. With NAF ECs, as users enter information, such as opinions about a restaurant or a local place or some other useful and non-private information, the architecture envisioned in this disclosure attaches/tags NAF specific information (such as city or neighborhood information), topic category, and other attributes. Such tagged and categorized information lends itself to easy searching (without resorting to complicated search expressions or complicated search engines) by users and resulting in more relevant searches. All categorized and tagged information maintained in a particular EC or across multiple ECs can be easily found through external search engines if access to EC(s) portal to external search engines is allowed. The results provided by such external search engines are owned by this invention in so far as the search engines exploit the categorization already performed by EC products. The method and the algorithms used by a particular search engine are not relevant in so far as EC specific meta information associated with the information item is used by search engines. If the search results receive scores based on any or all categorization attributes performed by EC production then such search results are considered to be proprietary to this invention. Any advertisements placed along side search results that are based on use of EC categorization and tagging should be considered part of that EC (or split equally when there are multiple search results coming from multiple ECs) whose information items are displayed in the search results

NAF EC framework includes support for open EC ecosystem entry pages that span all ECs in that ecosystem. Users will be steered to their respective EC using ‘single entry’ (defined as a method involving user entering only userid and no password) method. This single entry will identify one's coordinates/location and result in user being taken to one's home EC. Where multiple home ECs exist for the given user in the ecosystem, user will be prompted to select one for the session. Only information that is configured to be made available to anonymous visitors is made available in such sessions. Users need to enter userID/location code only once during a session and the architecture re-uses that information as user visits different sections of EC or even a different EC. User is not required to do full login (defined as user entering userid/password). The framework also supports election of full-login/single entry. This choice is in place for those users who don't want to take chances in terms of somebody stealing their userid. For posting/conducting transactions, users will be prompted for full login to enter password or a key as the ‘second entry’. Today, a large part of user activity on internet is spent on browsing/searching and such activity doesn't require full 2-entry login (or in some cases 3-entry where the third entry could be a personal key such as zip code). With the ‘single entry’ method user still can remain anonymous and yet get the benefits of NAF based results/information during one's browsing. Such ‘single entry’ mechanism provides enhanced user experience as well as protection against identity theft as password is entered in the real case of performing some transaction thus minimizing the number of times users enter passwords. Additionally, due to the architecture and framework that stores multiple IDs with one account—users can use any of the additional IDs associated with the user while doing casual browsing but use a separate ID and associated password while performing any transactions thus providing increased protection against identity theft.

Another embodiment of this invention is the ability to provide visual views and visual search of a neighborhood using such technologies as VRML and or live/pre-recorded video, images, drawings, animations and other visual assets of properties, people, streets, malls, stores, and in general visual assets of any and/or all parts of the physical world to provide as near an experience as possible to that one would experience by physically visiting the entity or of its neighborhood of interest for similar purposes. Today there is no internet 3-D city or visual drive through application. NAF bases ECs can offer such futuristic applications and in so far as products exploit NAF EC relationship framework and architecture disclosed in this invention then such applications and associated business processes are to be considered as integral part of this invention. People are often interested in visual exploration of a business and its surroundings before selecting that business; visual exploration can be done to check the location and accessibility (not easy to find from simple address lookup), to check nearby businesses/surrounding environment. NAF based ECs, having modeled all neighborhood entities can easily display such information augmented with any visual assets mentioned above. As user drives through a visual neighborhood, user can find what they are looking for. This can be entertaining and may open more business opportunities other than visual search mentioned here. All such derivative applications are to be considered as embodiments to this invention and such variations are not to be regarded as departure from the spirit and scope of this invention.

Additional embodiments of a business process of this invention applies to offering NAF based EC solutions to communities associated with a single or set of properties. In such application, two different deployment modes are considered as follows: a) EC portal serving a neighborhood (such as an apartment complex or a housing community) offers property management functions and services for property (or properties) associated with that neighborhood; b) Property management solutions integrate EC features set forth in this disclosure. In either embodiment, management of relationship between residents/prospective tenants, or between residents and owners, (property management) is called Property Resident Relation Management (PRRM). This relationship management can benefit from reusing EC framework.

In mode (a) deployment, the functions of PRRM can be made available on an EC portal that contains the property (or set of properties treated as one block). For instance, owner/manager of property X, in city/community Y can register its property on an EC portal for that city/community, Y. The owner can setup membership accounts for all concerned with that property: owners, managers, residents and others associated with that property. Subsequently, visitors to city/community Y's portal, if they have a relationship with property X, can log into that section of the EC portal that is dedicated to property X. Once logged in, visitor can send a message to property manager for maintenance or other purpose. The user can also browse through sale notices in that property, etc. The property owners can be treaded as AYPs and allotted special sections/pages which contain special EC applications that implement a collective set of functions represented by Property Resident Relationship Management (PRRM)—leveraging some of the infrastructure used in building EC portal.

This invention models each property as owned by one or more owners and associated with one or more residents. The owner(s) and resident(s) may be the same. For instance, a home owner can be a resident if staying in the house. Other combinations between owner(s) and resident(s) are possible. For instance, with time-shared properties, at any time only some (typically one) stay in the property.

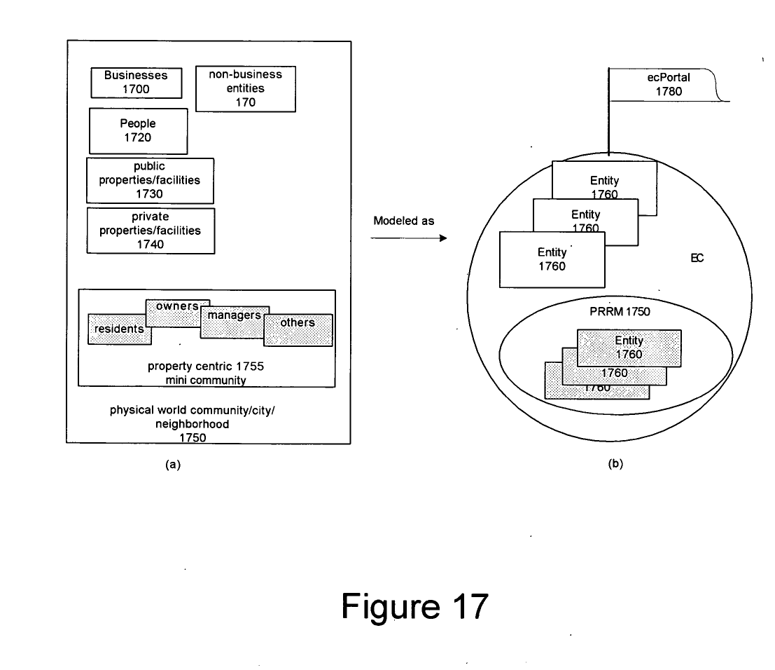

FIG. 17 illustrates an exemplary EC portal catering to a larger community as well as hosting special pages/sections to cater to a property and its associated entities (residents, owners, and property managers). These pages/sections related to property can be considered a sub portal within EC portal, in accordance with an embodiment of the present invention. This is called the PRRM mode of operation of NAF EC portal. This example consists of, physical neighborhood 1750 comprising business entities 1700, non-business entities 1710, people 1720, public entities 1730, private entities 1740, and property centric mini community 1755. Property centric mini community 1755 comprises managers, owners, residents and others associated with that property. As shown, neighborhood 1750 is modeled as EC 1770 containing one or more entities 1760 as well as containing PRRM EC 1785 An EC portal application 1780 provides an on-line platform for the neighborhood entities to interact, and share information as well as receive/offer services/help; buy/sell goods and services; bid/auction on goods and services. Members of EC 1785 can interact with their own community members as well as with those of 1770 seamlessly and participate in NAF EC interactions—post or respond to buy/sell, wanted, and projects related to goods/services, etc. However, members of EC 1785 will have their own circle—comprising of members of that community alone first. While posting they can decide to publish to just that community or to the containing community (or even post to other NAF ECs in their neighborhood).

Regardless of the chosen way to deploy, property owners (community owners/managers) may offer access to products based on this framework to tenants/residents. From the full set of features possible, all or limited set of features may be offered to users in such deployment. For instance, an apartment complex, X, can operate NAF based EC portal as part of its property management application or otherwise and let residents use it. Using such portal—residents can interact with their neighbors, other entities and with property owners with NAF EC features and processes. Residents and the entities may also use such portal—since it can provide affinity attributes—to launch searches and advertise sale of goods and services to any one in that property and surrounding ECs. Where a property owner offers EC portal to its tenants, access and use of such portal may be controlled by the owner including any moderation of posts. Many processes for letting residents post to the EC portal in such applications can be easily conceived and implemented given the overall frame work described in this invention and such variations are to be regarded as part of this invention.

A business process embodiment of this invention offers enhanced services to prospective tenants for rental properties, homes, apartment or condo complexes, commercial and a process that includes automation of all the activities associated with a new property lease, account/contact information capture, expected move-in date capture, credit check, automatic maintenance request to prep the property for the move in, document preparation, etc.

A notification embodiment of this invention comprises the ability for multi-tenant unit property managers to use products and solutions, based on concepts and framework disclosed in this invention, to route maintenance requests from residents automatically or manually to appropriate maintenance personnel and notify them through—email, phone, paging, fax, etc. The invention also comprises the ability for property managers to configure the notification based on the type of problem. For instance, no heat in an apartment complex in winter might be a higher priority problem that requires paging maintenance person for immediate attention.

An additional embodiment of the invention comprises the ability to consolidate all expenses and income associated with a property through the various activities available in the product. For instance, the cost of each maintenance item can be captured, along with keeping track of all rental payments, utility dues, association dues, salaries, etc.—so owners have real-time view of the operational efficiency/profit margin of each property/asset.

When applied to property management products, software technologies, and services based on this disclosure rely on defining, presenting, and maintaining associations (and relationships) specified or otherwise, between neighborhood property and its owner(s), resident(s), user(s), and its neighborhood (community), with one or multiple of these services enabling enhanced experience for property owners, residents, users, nearby businesses (as well as civic and other entities) as part of an eNeighborhood (EC) and enabling a cluster of these NAF EC portals to interact with each other forming a web microcosm at neighborhood/local level and a macrocosm of EC at a higher level.

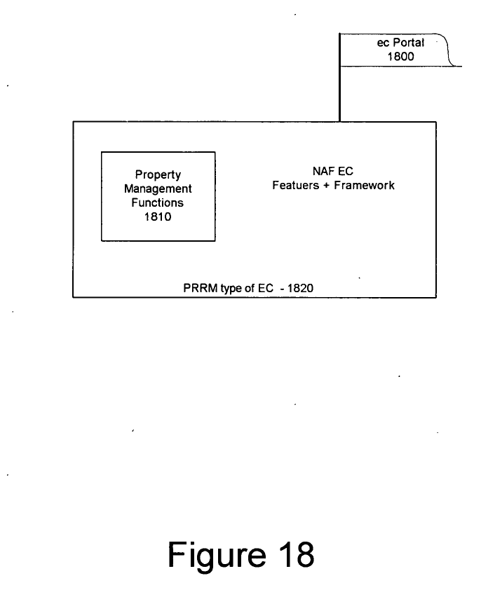

FIG. 18 illustrates exemplary property management solution integrating EC features in accordance with an embodiment of the present invention. This is part of Property Resident Relationship Management, PRRM, and mode of NAF EC deployment. PRRM, using EC principles and framework, framework and architecture allows combining property management functions 1810 with EC functions 1800 for an integrated solution communicable through EC portal 1820.

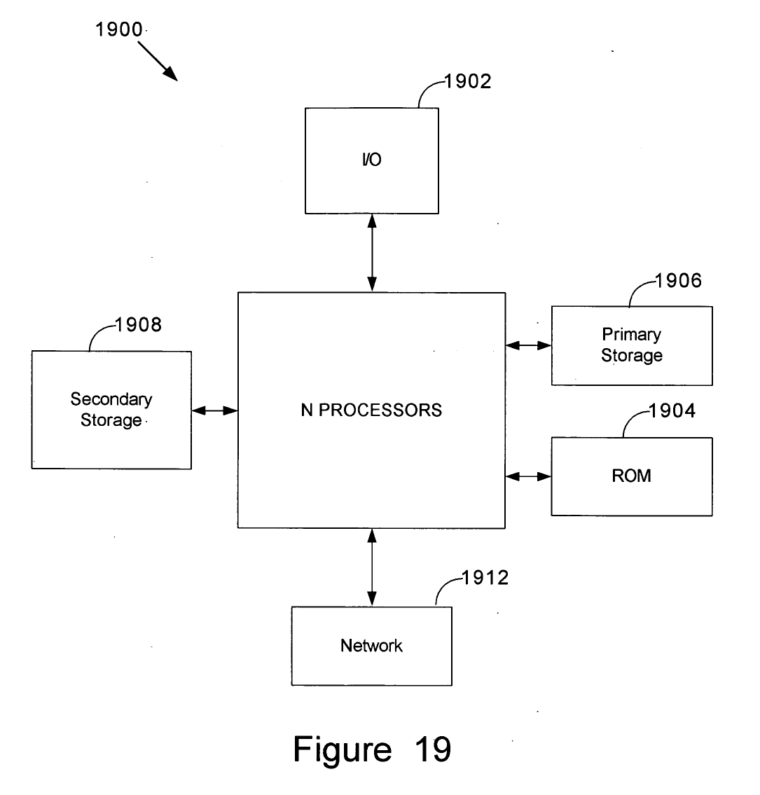

FIG. 19 illustrates a typical computer system that, when appropriately configured or designed, can serve as a computer system in which the invention may be embodied. The computer system 1900 includes any number of processors 1902 (also referred to as central processing units, or CPUs) that are coupled to storage devices including primary storage 1906 (typically a random access memory, or RAM), primary storage 1904 (typically a read only memory, or ROM). CPU 1902 may be of various types including microcontrollers and microprocessors such as programmable devices (e.g., CPLDs and FPGAs) and unprogrammable devices such as gate array ASICs or general purpose microprocessors. As is well known in the art, primary storage 1904 acts to transfer data and instructions uni-directionally to the CPU and primary storage 1906 is used typically to transfer data and instructions in a bi-directional manner. Both of these primary storage devices may include any suitable computer-readable media such as those described above. A mass storage device 1908 may also be coupled bi-directionally to CPU 1902 and provides additional data storage capacity and may include any of the computer-readable media described above. Mass storage device 1908 may be used to store programs, data and the like and is typically a secondary storage medium such as a hard disk. It will be appreciated that the information retained within the mass storage device 1908, may, in appropriate cases, be incorporated in standard fashion as part of primary storage 1906 as virtual memory. A specific mass storage device such as a CD-ROM 1914 may also pass data uni-directionally to the CPU.

CPU 1902 may also be coupled to an interface 1910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1902 optionally may be coupled to an external device such as a database or a computer or telecommunications or internet network using an external connection as shown generally at 1912. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitable replaced, reordered, removed and additional steps and/or system modules may be inserted depending upon the needs of the particular application, and that the systems of the present embodiment may be implemented using any of a wide variety of suitable processes and system modules, and is not limited to any particular computer hardware, software, firmware, microcode and the like.

Having fully described at least one embodiment of the present invention, other equivalent or alternative methods of implementing neighborhood affinity based online environments according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for an online community, the method comprising:
steps for establishing at least one neighborhood affinity based online community, and further based on related users; and
steps for enabling at least one of said related users to be associated with at least one online community.

2. The method of claim 1 further comprising steps for enabling single sign on of at least one of said related users to login into to a NAF online community to which the said user is a member and from that login session be able to login to other said online communities of an ecosystem

3. The method of claim 1 further comprising steps for match-making between one of said related users and at least one other of said related users.

4. The method of claim 1 further comprising steps for advertising, both targeted and otherwise, by businesses to at least one of said related users in at least one of said neighborhood affinity based online communities.

5. The method of claim 4 further comprising steps for gathering and using transactional data of said related users to gather market intelligence data; and the ability of NAF EC portal operators to offer based on such gathered data market data services to business to let them better target products, services, and marketing campaigns to users of at least one of said neighborhood affinity based online communities.

6. The method of claim 1 further comprising steps for automating advertisement submissions to at least one of said neighborhood affinity based online communities.

7. The method of claim 1 further comprising steps for entering and posting information related to at least one of said neighborhood affinity based online communities to help at least one of said related users with such information.

8. The method of claim 1 further comprising steps for a record keeping service.

9. The method of claim 1 further comprising steps for searching for wanted or sales or auction or project postings in a neighborhood or in a set of neighborhoods belonging to at least one of said neighborhood affinity based online communities.

10. The method of claim 1 further comprising steps for distributing at least one eCoupons to at least one of said related users in at least one of said neighborhood affinity based online communities.

11. The method of claim 1 further comprising steps for assigning and referencing a unique identifier to a property or a user in at least one of said neighborhood affinity based online communities.

12. The method of claim 1 further comprising steps for enabling direct interactions between one of said related users and at least one other of said related users.

13. The method of claim 1 further comprising steps for creating and managing user identification (ID) associated with at least one account in at least one of said neighborhood affinity based online communities.

14. The method of claim 1 further comprising steps for identity management services associated with at least one of said neighborhood affinity based online communities.

15. The method of claim 1 further comprising steps for multi-way identity verification services associated with at least one of said neighborhood affinity based online communities.

16. The method of claim 1 further comprising steps for single entry identification of user and user's location coordinates for use by user and/or location based services associated with at least one of said neighborhood affinity based online communities.

17. The method of claim 1 further comprising steps for directory based lookup services associated with at least one of said neighborhood affinity based online communities.

18. The method of claim 1 further comprising steps for enabling the indexing by any search engine of at least a portion of the information maintained in at least one of said neighborhood affinity based online communities.

19. The method of claim 18 further comprising steps for generating revenue from the search results generated by the search engine(s).

20. The method of claim 1 further comprising steps for offering enhanced services to tenants (current or prospective) of a property associated with at least one of said neighborhood affinity based online communities.

21. The method of claim 1 further comprising steps for property resident relationship management.

22. The method of claim 1 further comprising steps for multi-tenant unit property managers to be notified of and to route maintenance requests from residents of a managed property to the appropriate maintenance personnel, said multi-tenant unit property, and residents thereof, being associated with at least one of said neighborhood affinity based online communities.

23. The method of claim 1 further comprising steps for consolidating all expenses and income associated with management of a property that is part of at least one of said neighborhood affinity based online communities, and ability to offer on-line summary to tenants of payment information—such as rent or other expenses owed by them

24. An apparatus for an online community, the apparatus comprising:
means for establishing at least one neighborhood affinity based online community, and further based on related users;
means for enabling at least one of said related users to be associated with at least one online community; and
means for enabling at least one of said related users to login into to and access least one online communities without having to login separately.

25. A computer program product for an online community, the computer program product comprising:
computer code that establishes at least one neighborhood affinity based online community, and further based on related users;
computer code that enables at least one of said related users to be associated with at least one online community;
computer code that enables at least one of said related users to login into to and access at least one online communities without having to login separately; and
a computer-readable medium that stores the computer code.

26. A computer program product according to claim 25 wherein the computer-readable medium is one selected from the group consisting of a data signal embodied in a carrier wave, a CD-ROM, a hard disk, a floppy disk, a tape drive, and semiconductor memory.
